(19) United States
(12) Patent Application Publication
(10) Pub. No.: US 2026/0313670 A1
(43) Pub. Date: Oct. 8, 2026

(54) DETECTION METHOD AND TARGET DEVICE

(71) Applicant: Lenovo (Beijing) Limited, Beijing (CN)

(72) Inventors: Jian CAO, Beijing (CN); Xiuqin LIU, Beijing (CN); Chunlei LI, Beijing (CN)

(21) Appl. No.: 19/178,614

(22) Filed: Apr. 14, 2025

(30) Foreign Application Priority Data
Apr. 26, 2024 (CN) 202410516946.7

(51) Int. Cl. H04W 72/51; H04B 7/06; H04W 48/02

(52) U.S. Cl. CPC H04W 72/51; H04B 7/0602; H04W 48/02

(57) ABSTRACT

The present disclosure provides a detection method and a target device, and the detection method includes, responding to the target device being of a first type, enabling a first module, where the first type of device supports wireless communication based on the first module; responding to the target device being of a second type, disabling the first module, where the second type of device merely supports wireless communication based on a second module, and the first module and the second module are different types of wireless communication modules in the target device.

### CROSS-REFERENCE TO RELATED APPLICATION

This application claims priority to Chinese Patent Application No. 202410516946.7, filed on Apr. 26, 2024, the content of which is incorporated herein by reference in its entirety.

### TECHNICAL FIELD

The application generally relates to the technical field of electronic devices, and in particular to a detection method and a target device.

### BACKGROUND

Currently, multiple different wireless modules can be configured on an electronic device, but the electronic device cannot determine which modules are permitted to be used or which modules are disabled, which may cause the electronic device to fail to comply with the provisions of relevant safety regulations, which then poses certain safety risks.

For example, for an electronic device equipped with a wireless fidelity (WiFi) module and a wireless wide area network (WWAN) module, it is impossible to effectively detect whether the WWAN module should be permitted to operate or disabled, which may result in non-compliance with safety regulations.

### SUMMARY

The present disclosure provides a detection method and a target device. The technical solution of the present disclosure is implemented as follows.

In a first aspect, an embodiment of the present disclosure provides a detection method, and the method includes, responding to a target device being of a first type, enabling a first module, where the first type of device supports wireless communication based on the first module, and responding to the target device being of a second type, disabling the first module, wherein the second type of device merely supports wireless communication based on the second module, and the first module and the second module are different types of wireless communication modules in the target device.

In a second aspect, an embodiment of the present disclosure provides a target device, including a first module and a second module, where the first module and the second module are different types of wireless communication modules in the target device, and the first module can be enabled or disabled by the target device based on a type of the target device itself, when the target device is of a first type, the first module is enabled, and when the target device is of a second type, the first module is disabled.

Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solution in the embodiments of the disclosure, the drawings essential for understanding the disclosed embodiments will be briefly described below. Apparently, the drawings described below are merely some embodiments of the disclosure. For a person skilled in the art, other drawings can be obtained based on the provided drawings without making creative efforts.

FIG. 1 is a flow chart of a detection method according to an embodiment of the present disclosure;

FIG. 2 is a schematic structural diagram of a target device according to an embodiment of the present disclosure;

FIG. 3 is a schematic structural diagram of another target device according to an embodiment of the present disclosure;

FIG. 4 is a flow chart of another detection method according to an embodiment of the present disclosure.

FIG. 5 is a schematic structural diagram of yet another target device according to an embodiment of the present disclosure;

FIG. 6 is a schematic structural diagram of yet another target device according to an embodiment of the present disclosure; and

FIG. 7 is a schematic diagram showing a comparison between a first screw and a second screw according to an embodiment of the present disclosure.

### DETAILED DESCRIPTION

In order to enable a more detailed understanding of the features and technical contents of the embodiments of the present disclosure, the implementation of the embodiments of the present disclosure is described in detail below in conjunction with the accompanying drawings. The accompanying drawings are merely for reference purposes and are not used to limit the embodiments of the present disclosure.

Unless otherwise defined, technical and scientific terms used herein have the same meaning as those commonly understood by a person skilled in the art. The terms used herein are merely for the purpose of describing the embodiments of the present disclosure and are not intended to limit the disclosure.

In the following description, reference is made to “some embodiments”, which describe a subset of all possible embodiments, but it will be understood that “some embodiments” may be the same subset or different subsets of all possible embodiments and may be combined with each other without conflict.

It should also be noted that the terms “first/second/third” in the embodiments of the present disclosure are merely used to distinguish similar objects and do not represent a specific ordering of the objects. It can be understood that “first/second/third” can be interchanged in a specific order or sequence where permitted, so that the embodiments of the present disclosure described here can be implemented in an order other than that illustrated or described here.

Electronic devices are usually equipped with multiple wireless modules to support electronic devices in accessing the Internet in different ways. However, currently, electronic devices cannot determine which modules should be allowed (or permitted) to be used or which modules should be disabled, which may make the electronic devices fail to comply with the provisions of relevant safety regulations and pose certain safety risks.

Take the example of an electronic device equipped with a WiFi module and a WWAN module. The WiFi module is a standard module on an electronic device and is a module used for wireless network connection. After the WiFi module is connected to a router, the router receives the data from the Internet and sends it to the WiFi module in the form of a wireless signal. Further, the WiFi module receives the wireless signal and converts it into a data packet that can be recognized by the electronic device, so that the electronic device can obtain data from the Internet. Alternatively, the electronic device can also package data to be sent to the Internet into a data packet, and the WiFi module converts the data packet into a wireless signal and sends it to the router. After the router receives the wireless signal, the router forwards the signal to the Internet.

The WWAN module is an optional module for electronic devices. It is a module that enables electronic devices to directly connect to the Internet anywhere within the coverage of the cellular network, and then directly communicate with remote network computers in the Internet. Here, the cellular network can include the global system for mobile communications (GSM) network, the general packet radio service (GPRS) network, the fourth generation mobile communication technology (4G) network, etc.

For electronic devices configured with WiFi modules and WWAN modules, there are two different types, one that merely supports the operation of a WiFi module, and the other that can support the operation of a WiFi module and a WWAN module. However, for economic reasons, the motherboard molds used by the different types of electronic devices are universal. For electronic devices that merely support a WiFi module, although the motherboard is not configured with a WWAN module, the motherboard still retains the relevant components that support the WWAN module. In this way, users may purchase a WWAN module from other channels and configure them on electronic devices by themselves. However, it is impossible for electronic devices to detect and identify such illegal operations. Therefore, in this case, the WWAN module configured privately by these users can work normally.

However, according to the relevant safety regulations, electronic devices that merely support WiFi modules cannot allow WWAN modules to work normally. The illegal operation of these users not only does not comply with the relevant safety regulations, but also has certain safety hazards. Therefore, it is necessary to make electronic devices that merely support WiFi modules no longer support illegal operations of users, so as to meet the requirements of safety regulations.

Based on the above technical problems, the present disclosure provides a detection method and a target device, which can enable a first module when the target device is of a first type, and disable the first module when the target device is of a second type. Thus, the target device can effectively detect the type of the target device, and disable the first module in time when the target device does not support the first module, avoiding the safety hazards caused by a user's illegal operation, making the target device meet the requirements of safety regulations, thereby improving the safety and stability of the target device.

The present disclosure is further described in detail hereinafter through the accompanying drawings and specific embodiments.

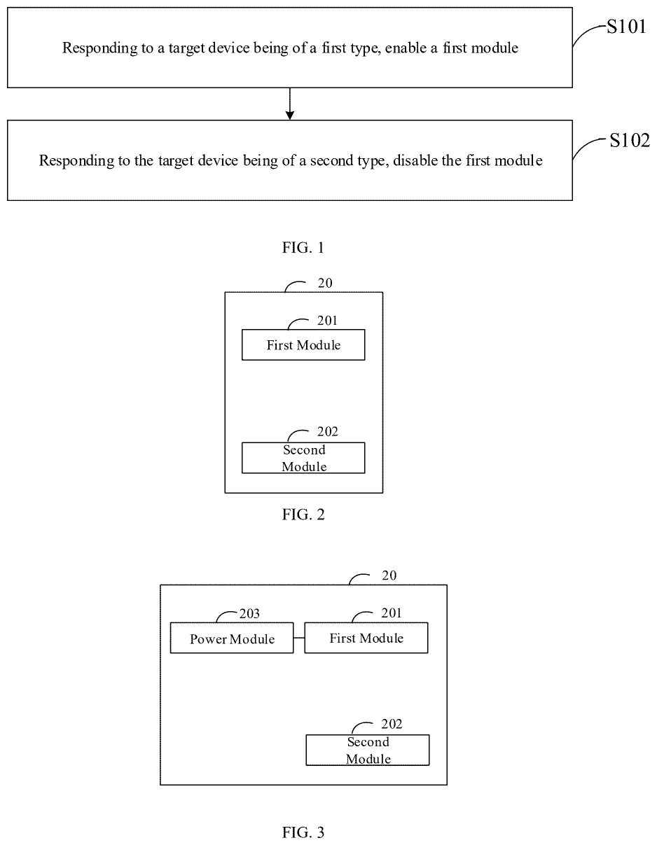

FIG. 1 is a flow chart of a detection method according to an embodiment of the present disclosure. As shown in FIG. 1, the detection method may include the following.

S101: Responding to a target device being of a first type, enable a first module.

A first type of device supports wireless communication based on the first module.

It should be noted that the detection method can be applied to a target device, and the target device can be the aforementioned electronic device, such as a laptop computer, a desktop host, etc., which are not listed here one by one.

In an embodiment of the present disclosure, multiple wireless modules can be configured on a target device. Exemplarily, the first module may be a WWAN module, which is configured to support the target device to communicate via a wide area network and is an optional module on the target device.

In an embodiment of the present disclosure, the second module may be a WiFi module, which is configured to support the target device to communicate via a local area network and is a standard module on the target device.

It can be understood that although both the WiFi module and the WWAN module can realize data transmission, there are differences between the two modules in terms of usage range, protocol, bandwidth, rate, transmission method, etc. Therefore, the WiFi module and the WWAN module are completely different types of wireless communication modules.

It should be noted that the target device is of the first type, which may mean that the target device is configured with the first module and the second module at the same time when leaving the factory. When it is determined that the target device is of the first type, the target device supports the normal operation of the first module and the second module, and both the first module and the second module are enabled. The target device can perform wireless communication based on the first module and the second module.

S102: Responding to the target device being of a second type, disable the first module.

The second type of device merely supports wireless communication based on the second module.

In the embodiments of the present disclosure, the first module and the second module are different types of wireless communication modules in the target device.

It should be noted that the target device is of the second type, which may mean that the target device is merely configured with a second module when leaving the factory. In this way, when it is determined that the target device is of the second type, the target device merely needs to support the normal operation of the second module, the first module is disabled by the target device, and the target device can merely perform wireless communication based on the second module.

In a case that the target device is of the second type, even if a user illegally installs the first module on the target device of the second type, the first module cannot operate normally because the first module is disabled.

Embodiments of the present disclosure provide a detection method, which can enable the first module when the target device is of the first type, or disable the first module when the target device is of the second type. The target device can determine whether the first module can be used based on its own type, avoiding security risks caused by illegal operations of users, thereby making the target device meet the requirements of safety regulations, and improving the security and stability of the target device.

FIG. 2 is a schematic structural diagram of a target device according to an embodiment of the present disclosure. As shown in FIG. 2, the target device 20 may include a first module 201 and a second module 202, where the first module 201 and the second module 202 are different types of wireless communication modules in the target device 20.

The first module 201 can be enabled or disabled by the target device 20 based on the type of the target device 20 itself. When the target device 20 is of the first type, the first module 201 is enabled. When the target device 20 is of the second type, the first module 201 is disabled.

As mentioned above, illustratively, the first module 201 may be a WWAN module, and the second module 202 may be a WiFi module. There are two types of WWAN modules, the first type of WWAN module includes a WWAN network card and an antenna unit. The second type of WWAN module includes merely an antenna unit. The corresponding card slots of these two types of WWAN modules on the target device are universal, that is, even if the target device 20 is configured with the second type of WWAN module, the target device 20 still retains a card slot for a WWAN network card even if the WWAN network card is not inserted.

It should also be noted that, when the target device 20 can simultaneously support the normal operation of the first module 201 and the second module 202, that is, when the WiFi module and the WWAN module are configured at the factory, the type of the target device 20 can be the first type. That is, the target device 20 can simultaneously support the operation of the WiFi module and the WWAN module. Here, when the target device 20 is of the first type, it can be further divided into two specific models, the first model is WWAN sku, and the WWAN module configured in the target device 20 of this model is the first type. That is, the WWAN module including the WWAN network card and the antenna unit is configured. The second model is WWAN ready, and the WWAN module configured in the target device 20 of this model is the second type, that is, the WWAN module merely including the antenna unit is configured. It can be understood that no matter what specific model the target device 20 is, since the WWAN module is configured, these two types of target devices 20 are both capable of simultaneously supporting the normal operation of the WiFi module and the WWAN module, and therefore belong to the first type.

In addition, when the target device 20 merely supports the second module 202, that is, when merely the WiFi module is configured at the factory, the target device 20 can be of the second type. When the target device 20 is of the second type, the target device 20 still retains the relevant components supporting the WWAN module, but in the embodiments of the present disclosure, these relevant components are enhanced in hardware structure, so that after the target device 20 is determined to be of the second type and the first module 201 is disabled, even if a user inserts a WWAN card purchased on the market, the target device 20 cannot support the normal operation of the WWAN module.

In the embodiments of the present disclosure, based on the above description, when it is determined that the target device 20 is of the first type, the first module 201 is enabled to work normally. When it is determined that the target device 20 is of the second type, the first module 201 is disabled to prevent it from working.

FIG. 3 is a schematic structural diagram of another target device according to an embodiment of the present disclosure. As shown in FIG. 3, the first module 201 has a target structure, and the target device 20 further includes a power module 203.

The target structure is configured to enable the target device 20 to obtain the first signal, and the ability to obtain the first signal indicates that the target device 20 is of the first type.

It should be noted that, as mentioned above, the first module 201 may include a WWAN network card and an antenna unit, or may merely include an antenna unit, but for the first module 201 that merely includes an antenna unit, the relevant slot of the WWAN network card is still retained. In the embodiments of the present disclosure, the first module 201 has a target structure, which may refer to a structure of the first module 201 after enhancing the card slot side of the WWAN network card fixed in the first module 201, or the antenna unit side of the first module 201, or other hardware structures related to the first module 201, so that the target device 20 can obtain the first signal when the target device 20 is configured with the first module 201 having the structure.

It should also be noted that, illustratively, the first signal may be a signal that enables the target device 20 to identify and detect its own type through a level state, such as a ground (GND) signal.

As mentioned above, when the target device 20 is of the first type, the device can support the normal operation of the first module 201 and the second module 202. When the target device 20 is of the second type, the device merely supports the normal operation of the second module 202, and the first module 201 is disabled. Therefore, when the first module 201 on the target device 20 is a first module 201 with a target structure, the target device 20 obtains the first signal, and then determines that the target device 20 includes the first module 201, so the target device 20 can determine that its type is the first type including the first module 201.

In the embodiments of the present disclosure, the target structure is also configured to influence the power supply of a power module 203 to the first module 201.

When the power module 203 is in a power-on state, the first module 201 is enabled. When the power module 203 is in a power-off state, the first module 201 is disabled.

It should also be noted that, as mentioned above, the target device 20 can obtain the first signal when the first module 201 with the target structure is configured, and then determine that the target device 20 is the first type that can support the normal operation of the first module 201. Further, after the target device 20 determines that it is the first type, the target device 20 can control the power module 203 to supply power to the first module 201 normally, thereby enabling the first module 201. Alternatively, when the target device 20 is not configured with the first module 201 with the target structure, it cannot obtain the first signal, and thus determines that its type is the second type and does not support the normal operation of the first module 201. In this case, the target device 20 can control the power module 203 not to supply power to the first module 201, thereby disabling the first module 201.

In this way, when a user purchases a target device 20 of the second type and attempts to change the type of the target device 20 to the first type by directly configuring a first module 201 purchased externally on the target device 20, since the first module 201 purchased externally does not have the target structure, the target device 20 cannot obtain the first signal, the power supply to the first module is disconnected, and the first module 201 is disabled, thereby invalidating the user's illegal operation and ensuring that the target device 20 complies with safety regulations.

Embodiments of the present disclosure provide a target device, which can determine whether to disable the first module according to the type of the target device, and control whether the first module can be enabled by controlling whether the power module supplies power to the first module. In this way, the target device meets the safety requirements, which then improves the safety of the target device.

FIG. 4 is a flow chart of another detection method according to an embodiment of the present disclosure. As shown in FIG. 4, the method may further include the following steps.

S301: Responding to a target device obtaining a first signal, determine that the target device is of a first type.

It should be noted that, as in the above embodiments, when the target device is of the first type, the first module is enabled. When the target device is of the second type, merely the second module is supported to operate normally, and the first module is disabled. Therefore, when the first module with the target structure is configured on the target device, a first signal can be generated and obtained by the target device, so that the target device can determine that it is configured with the first module, and therefore can determine that the type of the target device is the first type configured with the first module and the second module.

The first signal may be a ground signal.

S302: Responding to the target device failing to obtain the first signal, determine that the target device is of the second type.

The obtained first signal indicates that the first module has a target structure, and the target structure is configured to affect the power supply of the power module to the first module. The first module is enabled in the power-on state and disabled in the power-off state.

It can be understood that when the first module has a target structure and is configured on a target device, a first signal can be generated. Then, when the first module with the target structure is not configured on the target device, the target device cannot obtain the first signal, thereby enabling the target device to determine that it is not configured with the first module, and thus determine that the type of the target device is the second type that is merely configured with the second module but not the first module.

Further, as described in the above embodiments, when the target device is of the first type, the target device can control the power module to turn on the power supply to the first module, enabling the first module. Alternatively, when the target device is of the second type, the target device can control the power module to turn off the power supply to the first module, disabling the first module.

Embodiments of the present disclosure provide a detection method, which enables the target device to determine the type of the target device according to whether the first signal can be obtained, and then enable or disable the first module by controlling the power module to the first module. In this way, the target device meets the safety requirements and improves the safety of the target device.

According to another embodiment of the present disclosure, referring continuously to FIG. 3, the target structure includes at least a first substructure and a second substructure, the first module 201 performs wireless communication under the operation of the first substructure and the second substructure, and the first substructure is different from the second substructure.

In the embodiments of the present disclosure, the target device 20 obtains the first signal generated by the first substructure and/or the second substructure.

It should be noted that the first module 201 has a first substructure, which may, for example, refer to a structure for enhancing the hardware structure of the antenna unit in the first module 201, so that the target device 20, when including the first module 201 and the first module 201 is connected to the antenna unit under the first substructure, can generate a first signal, which is acquired by the target device 20.

It should also be noted that the first module 201 has a second substructure, which may, for example, refer to a structure in which the hardware structure of the WWAN network card side of the first module 201, such as the card slot for fixing the WWAN network card and related components, is enhanced. In this way, the target device 20, when including the first module 201 and the first module 201 is inserted into the WWAN network card under the second substructure, can generate a first signal, which is acquired by the target device 20.

It is to be noted that, for WWAN ready that does not include a WWAN network card, since the WWAN network card is not inserted, the target device 20 will not detect the first signal on the card slot side. In this case, the signal input on the card slot side can be ignored. However, as mentioned above, whether the first module 201 includes a WWAN network card or not, the card slot and related components for the WWAN network card are retained. Therefore, when the target device 20 is of the first type, whether the model of the target device 20 is WWAN sku or WWAN ready, hardware enhancements can still be made to at least one of the card slot side of the WWAN network card and the antenna unit.

Therefore, in the embodiments of the present disclosure, if merely the antenna unit side is enhanced by hardware, that is, when the first module 201 has a first substructure, the first signal obtained by the target device 20 can be generated by the action of the first substructure. If merely the card slot side is enhanced by hardware, that is, when the first module 201 has a second substructure, the first signal obtained by the target device 20 can be generated under the action of the second substructure. If hardware enhancements are made to both the antenna unit side and the card slot side in the first module 201, that is, when the first module 201 has a first substructure and a second substructure, the first signal obtained by the target device 20 can be generated under an action of the first substructure and the second substructure.

Embodiments of the present disclosure provide a target device. When the first module has the first substructure and/or the second substructure, the target device obtains a first signal, determines itself as the first type, and enables the first module. Alternatively, when the target device cannot obtain the first signal, the target device determines itself as the second type, and disables the first module. Thus, by enhancing the hardware of different components in the first module, the target device can determine its own type, and then determine whether it supports the operation of the first module. If the target device does not support the operation of the first module, the first module is directly disabled, invalidating a user's illegal operation, thereby improving the security of the target device.

According to another embodiment of the present disclosure, in the above step S301, regarding responding to the target device obtaining the first signal, this step may include responding to the target device obtaining the first signal in a first mode.

The first mode represents a mode based on the first substructure, where the target structure includes at least the first substructure and the second substructure, the first module performs wireless communication under the operation of the first substructure and the second substructure, and the first substructure is different from the second substructure.

It should be noted that, based on the following embodiments, the first mode may be a mode of generating a first signal by setting a grounding unit in the antenna unit of the first module, so that the target device obtains the first signal. Further, after obtaining the first signal, the target device can determine that the type of the target device is the first type, enable the first module, and thus perform wireless communication based on the first module having the first substructure.

FIG. 5 is a schematic structural diagram of another target device structure according to an embodiment of the present disclosure. As shown in FIG. 5, the first substructure includes a grounding unit 2051, and the grounding unit 2051 is configured to enable the target device 20 to obtain the first signal.

It should be noted that FIG. 5 merely shows the enhanced structure on the antenna unit 2011 side, that is, the first substructure, and does not show the connection method of the power module and the structure on the card slot side. The connection method of the power module can refer to the aforementioned embodiments, and the structure on the card slot side can be the second substructure in the following embodiments, or other structures, which are determined according to the actual needs of the users and are not specifically limited here.

In the embodiments of the present disclosure, as shown in FIG. 5, the target device 20 may include a motherboard (MB) 204, which is provided with a detection chip 2041. The detection chip 2041 may be a system-on-chip (SoC) or an embedded controller chip (EC), etc., which is a chip capable of managing and controlling the working states of the first module, the second module, the power module, and other modules in the target device 20. The detection chip 2041 is connected to the first module having the first substructure through a general-purpose input/output (GPIO) interface, that is, connected to the antenna unit 2011 including the grounding unit 2051. Here, the antenna unit 2011 can be an antenna hardware interface (ANT), and the antenna unit 2011 and the motherboard 204 can be connected through a flexible flat cable connector (FFC) 205, or through an eDP cable, which is not limited in the present disclosure. In addition, for a laptop computer, the position of the antenna can be set above the screen, and the GND signal of the antenna is connected to the screen. Through wiring on the screen, the GND signal is connected from the GPIO interface on the screen connector to the EC/BIOS on the motherboard.

In the embodiments of the present disclosure, when the target device 20 is of the first type, the target device 20 includes a first module having a first substructure, that is, an antenna unit 2011 having a grounding unit 2051. After the grounding unit 2051 in the antenna unit 2011 is connected to the detection chip 2041 on the target device 20, the voltage of the GPIO interface of the detection chip 2041 is pulled down to a voltage close to the ground, so that the detection chip 2041 obtains the first signal. It can be understood that the first signal can be a ground signal.

In addition, when the target device 20 is of the second type, it does not include the first module with the first substructure. The voltage of the GPIO interface of the detection chip 2041 is in a floating state because it is not grounded. The voltage of the GPIO interface of the detection chip 2041 is not close to the ground, and the detection chip 2041 cannot obtain the first signal.

It should be noted that the detection chip 2041 and the power module can also be connected through the GPIO interface. In some embodiments, the power module and the antenna unit 2011 are connected to the detection chip 2041 through two different groups of GPIO interfaces. In this case, the detection chip 2041 detects the first signal through a group of GPIO interfaces connected to the antenna unit 2011, and determines that its own type is the first type. To enable the first module, a high-level signal can be sent to the power module through the other group of GPIO interfaces connected to the power module to control the power module to supply power to the first module. When the first signal cannot be detected, a low-level signal is sent to the power module. The power module is controlled not to supply power to the first module. In some embodiments, the power module and the antenna unit 2011 are connected to the detection chip 2041 through the same group of GPIO interfaces. In this case, the detection chip 2041 detects the first signal through some pins in the GPIO interfaces connected to the antenna unit 2011, and determines that its own type is the first type. To enable the first module, a high-level signal can be sent to the power module through other pins in the group of GPIO interfaces to control the power module to supply power to the first module. When the first signal cannot be detected, a low-level signal is sent to the power module to control the power module not to supply power to the first module.

In some embodiments, referring continuously to FIG. 5, the target device 20 further includes a pull-up resistor unit 2042, which is configured to enable the target device 20 to obtain a second signal different from the first signal when the target device 20 cannot obtain the first signal.

In the embodiments of the present disclosure, as shown in FIG. 5, a pull-up resistor unit 2042 may be further provided on the mainboard between the grounding unit 2051 and the GPIO interface connected to the detection chip 2041. The pull-up resistor unit 2042 may include a first resistor and a power supply, and the resistance value of the first resistor and the voltage value of the power supply may be determined according to actual application needs.

It should be noted that when the target device 20 is of the second type, it is not connected to the antenna unit 2011 having a grounding unit 2051, and the pins of the GPIO interface are in a floating state, which is easily interfered with and causes erroneous operation. In order to avoid this situation, a pull-up resistor unit 2042 can be set so that the target device 20 can obtain the second signal to ensure that the GPIO interface is in a stable state. Here, the pull-up resistor unit 2042 pulls up the level state of the GPIO interface and clamps it at a high level, and the second signal can refer to a high-level signal. It can be understood that when the target device 20 obtains the second signal, the target device 20 determines that its type is the second type.

In addition, when the target device 20 is of the first type, it is connected to the antenna unit 2011 having the grounding unit 2051. At this time, the grounding unit 2051 is connected to the GPIO interface of the detection chip 2041, and the voltage of the GPIO interface is pulled down from the high-level state pulled up by the pull-up resistor unit 2042 to near the ground, so that the target device 20 obtains the first signal and determines that its own type is the first type.

In general, for the first type of target device 20, such as the WWAN sku model or the WWAN ready model target device 20, since the antenna unit 2011 is configured, when the first module is connected, the voltage of the GPIO interface connected to the detection chip 2041 is lowered through the FFC 205 and the grounding unit 2051, and the target device 20 controls the power module to turn on the power supply to the first module. For the second type of target device 20, such as the WiFi sku model target device 20, since the antenna unit 2011 is not configured, the voltage of the GPIO interface of the detection chip is always in a pulled-up state due to the action of the pull-up resistor unit 2042, and the target device 20 controls the power module to turn off the power supply to the first module.

Embodiments of the present disclosure provide a target device, which can stably detect a first signal by setting a grounding unit in the antenna unit and a pull-up resistor unit on the mainboard when the target device is of the first type; and stably detect a second signal when the target device is of the second type. Even if a user installs a first module, the first module configured by the user cannot work normally because the target device cannot obtain the first signal and the first module is disabled. Therefore, the target device complies with safety regulations, which improves the safety of the target device.

In some embodiments of the present disclosure, in the above step S301, for responding to the target device obtaining the first signal, this step may also include responding to the target device obtaining the first signal in a first mode; and/or responding to the target device obtaining the first signal in a second mode.

The second mode represents a mode based on the second substructure, where the target structure includes at least a first substructure and a second substructure, the first module performs wireless communication under the operation of the first substructure and the second substructure, and the first substructure is different from the second substructure.

It should be noted that, based on the following embodiments, the second mode can be achieved by setting a first screw, a target hole post, and a conductive unit on the card slot side of the first module, and by locking the first screw on the target hole post to a first position. When the lower end of the first screw contacts the conductive unit, it is equivalent to grounding the GPIO interface, thereby lowering the voltage of the GPIO interface and enabling the target device to obtain the first signal.

Further, after obtaining the first signal, the target device can determine that the type of the target device is the first type, and enable the first module, so that wireless communication can be performed based on the first module with the second substructure.

It should be noted that a first module with a first substructure can be configured on the target device so that the target device obtains the first signal through a first mode; or a first module with a second substructure can be configured so that the target device obtains the first signal through a second mode; or a first module with a first substructure and a second substructure can be configured so that the target device obtains the first signal through a first mode and a second mode.

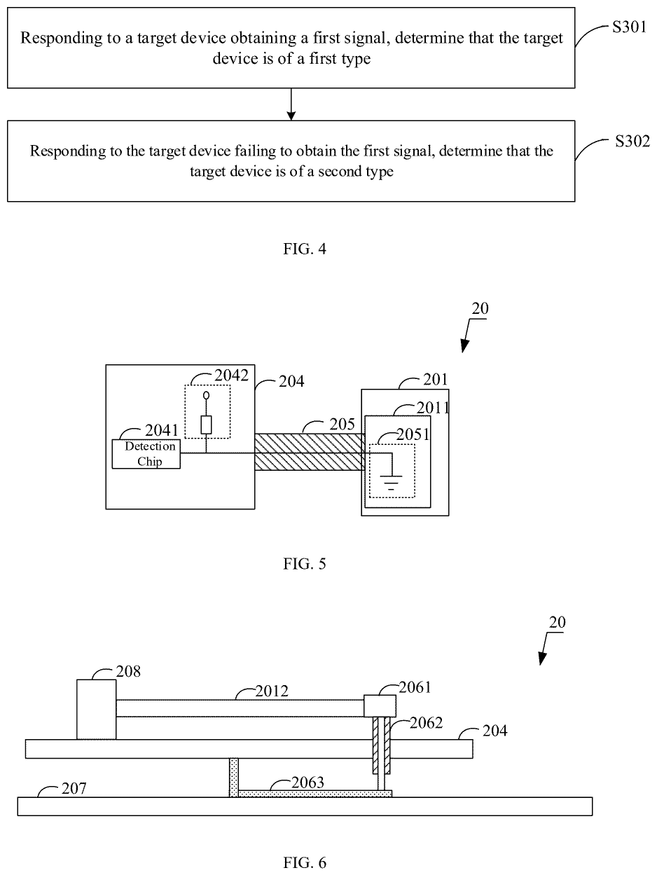

FIG. 6 is a schematic structural diagram of yet another target device according to an embodiment of the present disclosure. As shown in FIG. 6, the second substructure includes a first screw 2061, a target hole post (NUT) 2062, and a conductive unit 2063. The first screw 2061 is configured to screw into the target hole post 2062 to reach a first position and contact the conductive unit 2063, so that the target device 20 can obtain the first signal.

It should be noted that FIG. 6 merely shows the enhanced structure of the card slot side of the WWAN network card, that is, the second substructure, and does not show the connection method of the power module and the structure of the antenna unit side. The connection method of the power module can refer to the aforementioned embodiments, and the structure of the antenna unit side can be the first substructure in the aforementioned embodiments, or can be other structures, which are determined according to the actual needs of the user and are not limited here.

In the embodiments of the present disclosure, the second substructure of the first module may be a structure obtained by enhancing the card slot side of the WWAN network card 2012 in the first module, so that when the target device 20 is configured with the first module having the second substructure, the target device 20 can obtain the first signal and determine that the type of the target device 20 is the first type. Exemplarily, as shown in FIG. 6, the second substructure may include a first screw 2061, a target hole post 2062, and a conductive unit 2063.

The first screw 2061 may also be referred to as a WWAN screw, which may be a special screw, which is longer than a general screw and is merely used in the card slot of the WWAN network card 2012, and users cannot purchase it through market channels. The target hole post 2062 has an internal thread, which is used in conjunction with the external thread of the first screw 2061. As shown in FIG. 6, one end of the WWAN network card 2012 is connected to the motherboard 204 through an M2 connector (M2 CONN) 208, and the other end of the WWAN network card 2012 can be fixed by screwing the first screw 2061 into the target hole post 2062.

It should also be noted that the conductive unit 2063 can be arranged between a structural member 207 and the motherboard 204, and can be composed of a shrapnel or pogo pin vertically arranged between the motherboard 204 and the structural member 207. A conductive material is horizontally arranged on the structural member 207, one end of which is in contact with the shrapnel or pogo pin, and one side of which extends to the bottom of the first screw 2061. Here, the structural member 207 can also be called a C-part, which refers to a basic component that constitutes the target device 20 and can be used to fix and support other devices in the target device 20. In addition, the conductive material can be iron, aluminum foil, conductive cloth, and other conductive materials. The shrapnel or pogo pin is connected to the GPIO interface of the detection chip arranged on the motherboard 204.

In the embodiments of the present disclosure, the first screw 2061 is screwed downward into the first hole post until the lower end of the first screw 2061 contacts the conductive material in the conductive unit 2063, and the nut of the first screw 2061 contacts the top of the target hole post 2062. It can be considered that the first screw 2061 is locked into the target hole post 2062 and reaches the first position. It can be understood that in actual applications, the length of the first screw 2061 can be specifically determined according to the distance between the top of the target hole post 2062 and the conductive material on the structural member 207.

In this way, when the target device 20 is of the second type, the operation of the first module is not supported. Due to the presence of the conductive material in the conductive unit 2063, when the first screw 2061 contacts the conductive unit 2063, a circuit is formed. This causes the voltage at the GPIO interface of the detection chip to be clamped in a high level state, that is, the GPIO interface of the detection chip detects the second signal. The high level of the GPIO interface of the detection chip also results in a low-level output to the power module, thereby not supplying power to the first module. When the target device 20 is of the first type, whether it is a WWAN sku model or a WWAN ready model, the target device 20 supports the operation of the first module, and has related components on the card slot side. Therefore, when the first screw 2061 and the target hole post 2062 are locked and reach the first position, the first screw 2061 contacts the conductive material, and the voltage of the GPIO interface of the detection chip on the mainboard 204 is pulled down from a high level to near the ground through the shrapnel or the pogo pin, which is equivalent to the GPIO interface of the detection chip detecting the first signal, where the first signal can be a ground signal.

It should also be noted that, referring to the above embodiments, the detection chip, the conductive unit 2063, and the power module can be connected through a same group of GPIO interfaces, or through two different groups of GPIO interfaces. When connected through a same group of GPIO interfaces, if the detection chip detects a low-level first signal through some of the pins of the GPIO interfaces, the detection chip can send a high-level signal to the power module through the remaining pins of the group of GPIO interfaces to control the power module to turn on the power supply to the first module. Alternatively, if the detection chip detects a high-level second signal through some of the pins of the GPIO interfaces, the detection chip can send a low-level signal to the power module through the remaining pins of the group of GPIO interfaces to control the power module to turn off the power supply to the first module. Similarly, when connected through two different groups of GPIO interfaces, if the detection chip detects a low-level first signal through a group of GPIO interfaces connected to the conductive unit 2063, the detection chip can send a high-level signal to the power module through the other group of GPIO interfaces connected to the power module to control the power module to turn on the power supply to the first module. Alternatively, if the detection chip detects a high-level second signal through a group of GPIO interfaces connected to the conductive unit 2063, the detection chip can send a low-level signal to the power module through the other group of GPIO interfaces connected to the power module to control the power module to turn off the power supply to the first module.

It can be understood that when the target device 20 is of the first type, regardless of whether the target device 20 is a WWAN sku model or a WWAN ready model, it is necessary to turn on the power module to supply power to the M2 connector 208 of the WWAN module. When the target device 20 is of the second type, such as a WiFi sku, it is necessary to turn off the power module to supply power to the M2 connector 208 of the WWAN module.

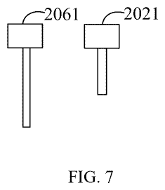

In some embodiments, the second module includes a second screw 2021. FIG. 7 is a schematic diagram showing a comparison between a first screw and a second screw according to an embodiment of the present disclosure. As shown in FIG. 7, the length of the second screw 2021 is shorter than the length of the first screw 2061.

The second screw 2021 is configured to prevent the target device from obtaining the first signal when it is screwed into the target hole post and reaches a second position that cannot contact the conductive unit.

In the embodiments of the present disclosure, the second screw 2021 can also be called a WiFi screw, and the second screw 2021 also has a matching second hole post. The second module, that is, the WiFi network card in the WiFi module, can be fixedly connected to the mainboard by locking the second screw 2021 on the second hole post. As shown in FIG. 7, according to the length comparison between the first screw 2061 and the second screw 2021, it can be seen that the length of the second screw 2021 can be shorter than that of the first screw 2061.

In this way, when the target device purchased by a user is of the second type, if the user purchases a first module from other channels, the WWAN network card in the first module can be fixed on the mainboard by removing the second screw 2021 and locking it to the target hole post. However, since the length of the second screw 2021 is shorter than the length of the first screw 2061, even if the second screw 2021 is completely screwed into the target hole post, that is, when the second screw 2021 is locked to the second position, the nut of the second screw 2021 contacts the top of the target hole post, but the lower end of the second screw 2021 is still a distance away from the conductive material in the conductive unit and cannot contact the conductive material on the structural member. In this case, the GPIO interface of the detection chip on the mainboard of the target device still detects the second signal but cannot detect the first signal. Therefore, the first module is still disabled and the user's illegal operation is ineffective.

When the target device purchased by a user is of the first type, as in the aforementioned embodiments, by locking the first screw 2061 to the first position, the detection chip detects the first signal, thereby controlling the power module to supply power to the first module, thereby enabling the first module.

It should be noted that, as mentioned above, when the target device is of the first type, the target device may merely include the first module with the first substructure, that is, the first module includes a card slot of a WWAN network card that does not include the first screw 2061, the target hole post and the conductive unit, and an antenna unit that includes a grounding unit. Alternatively, the target device may merely include the first module with the second substructure, that is, the first module includes a card slot of a WWAN network card that includes the first screw 2061, the target hole post, and the conductive unit, and an antenna unit that does not include a grounding unit. Alternatively, the target device may include the first module with both the first substructure and the second substructure, that is, the first module includes a card slot of a WWAN network card that includes the first screw 2061, the target hole post, and the conductive unit, and an antenna unit that includes a grounding unit. Users can choose from these according to specific needs.

In general, when the target device is of the first type, the first screw 2061 for fixing the WWAN network card in the target device is a specially made long screw when the target device leaves the factory. When the first screw 2061 is locked and reaches the first position, the lower end of the first screw 2061 contacts the conductive material, and the GPIO interface connecting the detection chip on the mainboard end with the shrapnel or pogo pin is pulled down via the shrapnel or pogo pin, thereby controlling the power module that supplies power to the WWAN connector in the first module to be turned on. Otherwise, the GPIO interface connecting the detection chip with the shrapnel or pogo pin is always in a high level state, controlling the power module that supplies power to the WWAN connector in the first module to be turned off.

Embodiments of the present disclosure provide a target device, where the second substructure includes a first screw, a target hole post and a conductive unit, and further, the second module includes a second screw, and the length of the second screw is shorter than the length of the first screw. Thus, when the target device includes a first module having a second substructure, the first screw is screwed into the target hole post to reach a first position, contacts the conductive unit, and enables the target device to obtain a first signal, determines that the type of the target device is the first type, and enables the first module. When the target device does not include a first module having a second substructure, a user is also unable to enable the target device to obtain the first signal by locking the second screw to the target hole post, and the target device still disables the first module. Thus, the target device meets the requirements of safety regulations, which improves the safety of the target device.

A person skilled in the art will appreciate that the exemplary units and algorithm steps described in conjunction with the embodiments disclosed in the present disclosure can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, but such implementation should not be considered to be beyond the scope of the disclosure.

It should be understood that “one embodiment” or “an embodiment” or “some embodiments” mentioned throughout the specification means that specific features, structures or characteristics related to the embodiment(s) are included in at least one embodiment of the present disclosure. Therefore, “in an embodiment”, “in one embodiment”, or “in some embodiments” appearing throughout the specification may not necessarily refer to the same embodiment. In addition, these specific features, structures or characteristics can be combined in one or more embodiments in any suitable manner. It should be understood that in various embodiments of the present disclosure, the sequence number of the above processes does not mean the order of execution, and the execution order of each process should be determined by its function and internal logic, and should not constitute any limitation on the implementation process of the embodiments of the present disclosure. The above sequence numbers of the embodiments of the present disclosure are merely for description and do not represent the advantages and disadvantages of the embodiments. The above description of each embodiment tends to emphasize the differences between the various embodiments, and the same or similar aspects can be referenced to each other. For the sake of brevity, these details will not be repeated in the disclosure.

It should also be noted that in the present disclosure, the terms “include”, “comprises” or any other variants thereof are intended to cover non-exclusive inclusion, so that a process, method, article, or device including a series of elements includes not only those elements, but also other elements not explicitly listed, or also includes elements inherent to such process, method, article or device. In the absence of further restrictions, an element defined by the sentence “comprises a . . . ” does not exclude the presence of other identical elements in the process, method, article, or device including the element.

The serial numbers of the above embodiments of the present disclosure are merely for descriptive purposes and do not represent the advantages or disadvantages of the embodiments.

The methods disclosed in several method embodiments provided in the disclosure can be arbitrarily combined without conflict to obtain new method embodiments.

The features disclosed in several device embodiments provided in the disclosure can be arbitrarily combined without conflict to obtain new device embodiments.

The features disclosed in several method or device embodiments provided in the disclosure can be arbitrarily combined without conflict to obtain new method embodiments or device embodiments.

The foregoing is merely some embodiments of the present disclosure and is not intended to limit the scope of protection of the present disclosure. Any modifications, equivalent substitutions, and improvements made within the spirit and principles of the present disclosure should fall within the scope of protection of the present disclosure.

What is claimed is:

1. A detection method, comprising:
responding to a target device being of a first type, enabling a first module, wherein the first type of device supports wireless communication based on the first module; and
responding to the target device being of a second type, disabling the first module, wherein the second type of device merely supports wireless communication based on a second module, and the first module and the second module are different types of wireless communication modules in the target device.

2. The method according to claim 1, further comprising:
responding to the target device obtaining a first signal, determining that the target device is of the first type; and
responding to the target device failing to obtain the first signal, determining that the target device is of the second type, wherein an ability to obtain the first signal indicates that the first module has a target structure, the target structure is configured to affect a power supply for the first module by a power module, and the first module is enabled in a power-on state and disabled in a power-off state.

3. The method according to claim 2, wherein responding to the target device obtaining the first signal comprises:
responding to the target device obtaining the first signal through a first mode; and/or,
responding to the target device obtaining the first signal through a second mode,
wherein the first mode represents a mode based on a first substructure, the second mode represents a mode based on a second substructure, the target structure includes at least the first substructure and the second substructure, the first module performs wireless communication under an operation of the first substructure and the second substructure, and the first substructure is different from the second substructure.

4. A target device, comprising a first module and a second module, wherein:
the first module and the second module are different types of wireless communication modules in the target device;
the first module is capable of being enabled or disabled by the target device based on a type of the target device itself;
when the target device is of a first type, the first module is enabled; and
when the target device is of a second type, the first module is disabled.

5. The target device according to claim 4, wherein:
the first module has a target structure, and the target device further includes a power module;
the target structure is configured to enable the target device to obtain a first signal, and an ability to obtain the first signal indicates that the target device is of the first type;
the target structure is further configured to affect a power supply of the power module to the first module;
when the power module is in a power-on state, the first module is enabled; and
when the power module is in a power-off state, the first module is disabled.

6. The target device according to claim 5, wherein:
the target structure includes at least a first substructure and a second substructure, the first module performs wireless communication under an operation of the first substructure and the second substructure, and the first substructure is different from the second substructure; and
the target device obtains the first signal generated by the first substructure and/or the second substructure.

7. The target device according to claim 6, wherein the first substructure includes a grounding unit, and the grounding unit is configured to enable the target device to obtain the first signal.

8. The target device according to claim 7, further comprising a pull-up resistor unit, wherein, when the target device is unable to obtain the first signal, the target device is capable of obtaining a second signal, wherein the second signal is different from the first signal.

9. The target device according to claim 7, wherein the first signal is a ground signal.

10. The target device according to claim 6, wherein the second substructure includes a first screw, a target hole post, and a conductive unit, and the first screw is configured to enable the target device to obtain the first signal when the first screw is screwed into the target hole post to reach a first position and contacts the conductive unit.

11. The target device according to claim 10, wherein:
the second module includes a second screw, and a length of the second screw is shorter than a length of the first screw; and
the second screw is configured to prevent the target device from obtaining the first signal when the second screw is screwed into the target hole post and reaches a second position and fails to contact the conductive unit.

12. The target device according to claim 5, wherein the first module is a wireless wide area network (WWAN) module, and the second module is a wireless fidelity (WiFi) module.

13. The target device according to claim 12, wherein the WWAN module is one of a first type of WWAN module including both a WWAN network card and an antenna unit or a second type of WWAN module including merely the antenna unit.

14. The target device according to claim 13, wherein corresponding card slots of the first type of WWAN module and the second type of WWAN module are universal.

15. The target device according to claim 12, wherein the second type of target device does not support a normal operation of the WWAN module even if a user inserts a WWAN network card into the target device.

16. The target device according to claim 13, wherein the target device includes a motherboard.

17. The target device according to claim 16, wherein, when the target device is of the second type, the motherboard still retains relevant components that support the WWAN module even the target device does not include the WWAN module.

18. The target device according to claim 17, wherein the motherboard is provided with a detection chip configured to manage and control a working state of the first module and/or a working state of the second module.

19. The target device according to claim 18, wherein the target device is of the second type, and the power module and the antenna unit are connected to the detection chip through two different groups of GPIO interfaces.

20. The target device according to claim 18, wherein the target device is of the second type, and the power module and the antenna unit are connected to the detection chip through two different sets of pins in a same group of GPIO interfaces.
